(19) United States
(12) Patent Application Publication
(10) Pub. No.: US 2006/0000859 A1
(43) Pub. Date: Jan. 5, 2006

(54) Load-bearing bracket intended to be mounted on a longitudinal roof rail of a motor vehicle

(76) Inventor: Ivar Frischer, Goteborg (SE)

Correspondence Address: OSTROLENK FABER GERB & SOFFEN, 1180 AVENUE OF THE AMERICAS, NEW YORK, NY, 100368403, US

(21) Appl. No.: 11/159,921

(22) Filed: Jun. 23, 2005

(30) Foreign Application Priority Data
Jul. 1, 2004 (SE) 0401701-8

(51) Int. Cl. B60R 9/00

(52) U.S. Cl. 224/315; 224/323

(57) ABSTRACT

Load-bearing bracket intended to be mounted on a longitudinal roof rail of a motor vehicle. A load-supporting bar which is substantially horizontal in the position of use is transverse with respect to the roof rail and has attachments for load-fasteners at the end portions of the bar. The underside of the bar has anchors in the form of a pair of downwardly projecting, resilient legs formed in one piece with the bar. When mounted on the roof rail, the legs straddle the roof rail and are anchored thereon. The bar extends as a cantilever support in one or both directions from the anchors of the bracket and transversely across the roof rail.

### BACKGROUND OF THE INVENTION

1. Technical Field

The present invention relates to a load-bearing bracket intended to be mounted on a longitudinal roof rail of a motor vehicle and suitable for transporting a small number of long objects for example.

2. Related Art

Longitudinal roof rails fixed in position are often found on cars of the estate type or of the so-called SUV type for the purpose of supporting transverse loading frames which are in turn fixed with their ends in the roof rails in order to support various types of loads. Such loading frames are used to transport relatively large and bulky objects. Even for transporting a small number of long, relatively lightweight objects, such as pipes, boards and the like, it is necessary to mount transverse loading frames which are fixed on the two roof rails.

U.S. Pat. No. 5,779,116 describes load-bearing brackets which comprise two or more arms connected to one another in a hinged manner, each with a cantilever arm with a load-bearing surface. On account of its construction, this bracket, designed as a clamp, has a two-part loading surface which is located high above the rail and is separated by a high projecting and obstructing central part which contains the actual hinge between the arms.

### DISCLOSURE OF THE INVENTION

It is an object of the present invention to provide a load-bearing bracket which, without the need for bulky loading frames to be mounted on both sides, is suitable for transporting a small number of lightweight, long objects and which brackets can be fixed in pairs on the same roof rail. The load-bearing bracket may be of simple construction, have a small number of parts, be able to be mounted quickly on the rail and have a load-bearing surface which may extend transversely across the rail and very close to the latter. For this purpose, the bracket according to the invention is distinguished by the features of the invention.

The invention concerns load-bearing bracket intended to be mounted on a longitudinal roof rail of a motor vehicle. A load-supporting bar which is substantially horizontal in the position of use is transverse with respect to the roof rail and has attachments for load-fasteners at the end portions of the bar. The underside of the bar has anchors in the form of a pair of downwardly projecting, resilient legs formed in one piece with the bar. When mounted on the roof rail, the legs straddle the roof rail and are anchored thereon. The bar extends as a cantilever support in one or both directions from the anchors of the bracket and transversely across the roof rail. A bracket of this type for a small load consisting of long objects can simply be pressed securely onto the roof rail and anchored firmly thereon with the aid of a suitable quick-acting lock.

Further features and advantages of the bracket according to the invention are explained in the following detailed description with reference to the attached drawing.

### BRIEF DESCRIPTION OF THE DRAWINGS

FIG. 1 is a perspective view of a first, asymmetrical embodiment of a load-bearing bracket according to the invention, mounted on a roof rail;

FIG. 2 shows an end view of the bracket in FIG. 1; and

FIG. 3 is an end view of a second, symmetrical embodiment of the bracket according to the invention.

### DETAILED DESCRIPTION OF PREFERRED EMBODIMENTS

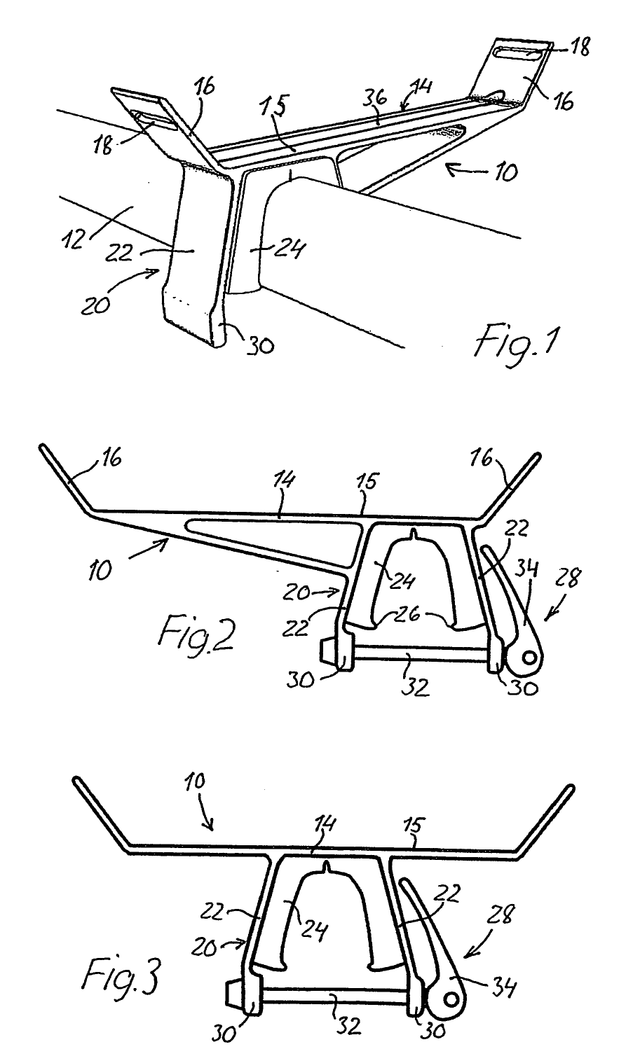

FIGS. 1 and 2 show a first embodiment of a load-bearing bracket 10 according to the invention. The bracket 10 is intended to be mounted on a longitudinal roof rail 12 of a motor vehicle. Possibly installed together with at least one further bracket 10 mounted on the same roof rail 12, the bracket may support a small number of long objects such as pipes, individual boards and the like (not shown). The bracket 10 for this purpose comprises a load-supporting bar 14 which at at least one of its transverse direction end portions preferably has upwardly projecting flanges 16 with some suitable form of fastening means, for example slits 18, for receiving load-fastening means, for example retaining straps, for securing the objects which are to be transported. The fastening means are a matter of choice.

Arranged on the underside of the bar 14 is an anchoring means 20 for anchoring the bracket 10 on the roof rail 12. The anchoring means 20 comprises a pair of spaced apart, opposing resilient legs 22 which project downwards from the underside of the bar 14 and which are designed such that, when mounted on the roof rail 12, they straddle the rail and are anchored thereon. The bar 14 and the anchoring legs 22 are formed in one piece, for example by extrusion of metal or a suitably strong plastic material.

The anchoring means 20 also preferably comprises an element 24 which is internally profiled to be adapted to the cross-sectional profile of the roof rail 12 and is also arranged between the legs 22 and the roof rail 12. The element 24 may be formed as a separate, exchangeable adapter part which can be adapted in shape to the profile of the actual rail, with the result that the bracket 10 can be used on the roof rails of different vehicles. Alternatively, the element 24 may from the outset be fixedly joined to the legs 22 and/or may be adapted to a specific rail profile.

The element 24 may have a substantially U-shaped cross-sectional profile with inwardly directed shoulders 26 at the ends of the legs of the U so that, when mounted on the roof rail 12, the legs and shoulders are able to spring outwards and the shoulders are able to snap in against the underside of said rail. The outer configuration of the element 24 is adapted to the configuration of the inside of the legs 22. There may be a form-fit connection (not shown) between the legs 22 and the element 24 in order to hold these parts together before and after mounting on the roof rail 12. To anchor the bracket 10 securely and forcibly on the roof rail 12, the anchoring means 20 also may comprise a suitable locking device element 28 (FIGS. 2 and 3) which joins the free end portions 30 of the legs 22 and, after placement of the bracket 10 on the rail 12, can press the legs 22, and thus the arms of the adapter element 24, firmly against the rail 12. The locking device 28 may comprise a pull rod 32 which releasably connects the end portions 30, and an eccentric arm 34 or the like for fixing the legs 22 and the adapter element 24 in a braced position.

In the asymmetrical embodiment according to FIG. 1, the load-bearing bar 14 of the bracket 10 extends out sideways of the rail 12 and from the anchoring means 20 to provide a cantilever support. The bracket 10 may be designed to be reversed in position so that it can be mounted either facing in towards or out from the roof rail 12 on the vehicle. In the embodiment according to FIG. 3, the bar 14 is arranged symmetrically sideways in relation to the anchoring means 20 so that it projects as a cantilever support by the same distance in opposite directions. In both cases, the bar 14 has a load-bearing surface 15 which extends transversely across the roof rail 12 and may be disposed very close to the rail for increased stability of the supported load.

Along the load-bearing surface 15 of the bar 14, a longitudinal, load-bearing elevation 36 (FIG. 1) may be arranged to compensate for any inclination of the bracket 10 caused by sloping of the roof rail 12 in its longitudinal direction.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A load-bearing bracket for mounting on a longitudinal roof rail of a motor vehicle, the bracket comprising:
a load-supporting bar which is substantially horizontal in a position of use, is directed to extend transversely with respect top the roof rail and, has end portions, including attachments for load-fasteners; the bar has an underside;
an anchor for the bar comprising a pair of downwardly projecting, spaced apart and opposing legs positioned and operable so that, when the legs are mounted on the roof rail, the legs are anchored on the rail, the bar and the downwardly projecting legs are formed such that the legs have a resiliency relative to the bar so that the legs may straddle and snap onto the roof rail; and
a load-bearing surface of the bar extending transversely across the roof rail.

2. A bracket according to claim 1, wherein the bar extends transversely and is operable as a cantilever support in at least one direction from the anchor of the bracket.

3. A bracket according to claim 1, wherein the bar extends transversely and is operable as a cantilever support in two opposite directions from the anchor of the bracket.

4. A bracket according to claim 1, wherein the anchor comprises a substantially U-shaped adapter element which is operable to be clamped securely against the roof rail, the adapter element having a contact surface adapted to a cross-sectional profile of the roof rail.

5. A bracket according to claim 4, wherein the adapter element has resilient side arms shaped to be snapped onto and grip around a substantial part of a perimeter of the roof rail.

6. A bracket according to claim 5, wherein the legs of the anchor are connectable with a form-fit to outsides of the arms of the adapter element.

7. A bracket according to claim 1, further comprising a locking device at the legs operable for locking the legs straddling the rail.

8. In combination, a roof rail for a motor vehicle and a bracket according to claim 4, wherein the roof rail has a cross-sectional profile and the adapter contact surface engages the profile.

9. In combination, a roof rail for a motor vehicle and a bracket according to claim 1, to which the legs of bracket may be shaped.
